(19) United States
(12) Patent Application Publication
(10) Pub. No.: US 2021/0142394 A1
(43) Pub. Date: May 13, 2021

(54) VIRTUAL SHOPPING SOFTWARE SYSTEM AND METHOD

(71) Applicant: Misho Milicevic, Port Coquitlam (CA)

(72) Inventor: Misho Milicevic, Port Coquitlam (CA)

(21) Appl. No.: 17/151,649

(22) Filed: Jan. 18, 2021

Related U.S. Application Data
(63) Continuation-in-part of application No. 16/348,464, filed on May 8, 2019, now abandoned.

(51) Int. Cl. G06Q 30/06; G06Q 30/02; G06Q 50/00; G06N 20/00; G06F 3/0484; G06T 19/20; G06F 3/0481; G06T 19/00

(52) U.S. Cl. CPC G06Q 30/0643; G06T 2219/2024; G06Q 30/0201; G06Q 30/0202; G06Q 30/0623; G06Q 30/0631; G06Q 50/01; G06Q 30/0603; G06Q 30/0639; G06N 20/00; G06F 3/0484; G06T 19/20; G06F 3/04815; G06T 19/006; G06T 2200/24; G06Q 30/0633

(57) ABSTRACT

The present invention relates to a virtual shopping system having a user interface, the user interface presenting a virtual storefront wherein the user interacts with the virtual storefront to perform shopping activities, the shopping activities being one or more of: viewing an item; purchasing an item; trying on an item; returning an item; and rejecting an item; a data collection system, the data collection system operative to collect data from the user performance of shopping activities, the collected data associated to the user and at least one store; a machine learning system, the machine learning system operative to analyze the collected data and produce data analysis results, the data analysis results producing one or more of: past individual user trends, predicted future individual user trends, past store trends and predicted future store trends. wherein the data analysis results are applied to modify the virtual storefront to present a customized virtual storefront to the user.

### CROSS REFERENCE TO RELATED APPLICATION

The present application is a continuation-in-part of U.S. patent application Ser. No. 16/348,464 filed on Mar. 8, 2019, which is a National Stage Entry of PCT/CA2017/051332 filed Nov. 8, 2017, which claims priority to U.S. Provisional Patent Application No. 62/419,301 filed Nov. 8, 2016, all of which are incorporated by reference herein in their entirety.

### FIELD OF INVENTION

The present specification relates generally to the field of online or virtual shopping and more specifically relates to a virtual shopping experience enhanced by machine learning.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

Online shopping or ecommerce has drastically increased as a form of consumer shopping. Online shopping allows consumers to directly buy goods or services from a seller over the Internet. Consumers find a product of interest by visiting the website of the retailer directly or by searching among alternative vendors using a search engine. There are apparent benefits of online shopping including no wait “time” required for shopping, better size selection/availability, but has the drawback that one cannot try on the article of clothing or accessory and see what it looks like on the shopper. Furthermore, consumers miss out on the “shopping” experience of socializing with other consumers or retailers. Therefore, a suitable solution is desired.

U.S. Pub. No. 2014/0108208 to Andrea Piana relates to a personalized virtual shopping assistant. The described personalized virtual shopping assistant includes a personalized virtual shopping assistant system and method which includes a plurality of individualized avatars which can be used by shoppers to see how various articles of clothing or accessories would look on themselves. The individualized avatars are created from a 3D body scan of all or a portion of the shopper to create an avatar which accurately reflects the size and shape of the shopper. When performing online shopping, the shopper retrieves his or her avatar for display on a display screen of a smartphone, tablet, computer, kiosk, or other device or system, and places computer representations of articles of clothing or accessories on the avatar. The computer representations are provided by the manufacturers or retailers or other sources. In some configurations, the computer representations may be manipulated to shrink or expand to fit the avatar. The personalized virtual shopping assistant system and method permits the shopper to “see” how a particular product or group of products “looks” on their body since they will be presented with the item(s) on an avatar of themselves.

Thus, while there are some virtual shopping systems known in the art, it would be desirable to have a virtual shopping system which may enhance the virtual shopping experience and/or which mitigates some of the disadvantages of the virtual shopping experience.

Accordingly, there remains a need for improvements in the art.

### SUMMARY OF THE INVENTION

In accordance with an aspect of the invention, there is provided a virtual shopping system which applies machine learning to produce an enhancing shopping experience for both users and stores.

According to an embodiment of the invention, there is provided a virtual shopping system, comprising: a user interface, the user interface presenting a virtual storefront wherein the user interacts with the virtual storefront to perform shopping activities, the shopping activities comprising one or more of: viewing an item; purchasing an item; trying on an item; returning an item; and rejecting an item; a data collection system, the data collection system operative to collect data from the user performance of shopping activities, the collected data associated to the user and at least one store; a machine learning system, the machine learning system operative to analyze the collected data and produce data analysis results, the data analysis results comprising one or more of: past individual user trends, predicted future individual user trends, past store trends and predicted future store trends. wherein the data analysis results are applied to modify the virtual storefront to present a customized virtual storefront to the user. The modifications to the virtual storefront may include one or more of: item color, item size and item availability.

According to a further embodiment of the invention, there is provided a virtual wardrobe, the virtual wardrobe operative to store virtual representations of clothing items, and an interface to produce a virtual representation of the user wearing one or more of the clothing items. The clothing items may comprise one or more of: clothing items purchased by the user; clothing items desired by the user; and clothing items suggested by the machine learning system.

According to a still further embodiment of the invention, there is provided a scrapbook, the scrapbook comprising one or more items selected by the user for future reference. The machine learning system may further analyze the scrapbook as part of the collected data.

According to another embodiment of the invention, the system may further comprise multiple virtual storefronts, each virtual storefront representing an individual retailer and each virtual storefront is individually modified. A virtual mall may then be created from a combination of the virtual storefronts.

The system may further include a social media interface, the social media interface providing for data exchange between the data collection system and one or more social media systems. The social media interface may further include a user interface to permit user sharing of data with other users of the social media systems.

The system may further include a catalog, the catalog comprising a virtual magazine, the virtual magazine comprising one or more virtual page displays containing one or more items for user interaction. The one or more items within the catalog may include items other than items available through the virtual storefront.

According to a further embodiment of the invention, the system may further comprise a 3-dimensional user avatar interface, the avatar interface comprising a 3-dimensional avatar of the user, the avatar created according to real-world data about the user, the real-world data including at least one physical measurement of the user. The avatar interface may further comprise an avatar item interface, the avatar item interface operative to permit the user to modify the avatar with one or more items to change how the avatar appears. The avatar item interface may comprise items selected from one of more of: items previously purchased by the user; items available from the virtual storefront, and items identified by the user for potential future purchase.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a front view of the virtual shopping software system and method during an ‘in-use’ condition, according to an embodiment of the disclosure.

FIG. 2 is a front view of the virtual shopping software system and method of FIG. 1, according to an embodiment of the present disclosure.

FIG. 3 is a front view of the virtual shopping software system and method of FIG. 1, according to an embodiment of the present disclosure.

FIG. 4 is a front view of the virtual shopping software system and method of FIG. 1, according to an embodiment of the present disclosure.

FIG. 5 is a front view of the virtual shopping software system and method of FIG. 1, according to an embodiment of the present disclosure.

FIG. 6 is a front view of the virtual shopping software system and method of FIG. 1, according to an embodiment of the present disclosure.

FIG. 7 is a front view of the virtual shopping software system and method of FIG. 1, according to an embodiment of the present disclosure.

FIG. 8 is a front view of the virtual shopping software system and method of FIG. 1, according to an embodiment of the present disclosure.

FIG. 9 is a front view of the virtual shopping software system and method of FIG. 1, according to an embodiment of the present disclosure.

FIG. 10 is a front view of the virtual shopping software system and method of FIG. 1, according to an embodiment of the present disclosure.

FIG. 11 is a block diagram of the interface elements of the virtual shopping system of FIG. 1.

Like reference numerals indicated like or corresponding elements in the drawings.

### DETAILED DESCRIPTION OF THE EMBODIMENTS

The present invention relates to a virtual shopping system and, in particular, a virtual shopping system comprising: a user interface, the user interface presenting a virtual storefront wherein the user interacts with the virtual storefront to perform shopping activities, the shopping activities comprising one or more of: viewing an item; purchasing an item; trying on an item; returning an item; and rejecting an item; a data collection system, the data collection system operative to collect data from the user performance of shopping activities, the collected data associated to the user and at least one store; a machine learning system, the machine learning system operative to analyze the collected data and produce data analysis results, the data analysis results comprising one or more of: past individual user trends, predicted future individual user trends, past store trends and predicted future store trends. wherein the data analysis results are applied to modify the virtual storefront to present a customized virtual storefront to the user.

Generally, the present disclosure provides a fully encompassing and strategically assembled software platform that can solve almost every problem or issue facing consumers and retailers alike in the online apparel markets, creating a synergy of the market to consumer relationship. With the present disclosure, users will finally have peace of mind with the ability to try on apparel and accessories using a three-dimensional (3D) anatomical avatar replica of themselves that works in coordination with a catalog, a scrapbook, a virtual-wardrobe, a social media sharing tool, and accurate 3D representations of apparel and accessory items supplied from a database to the product suppliers. The anatomical representations, modeled in 3D, can be generated through various methods, including but not limited to: images or video captured by the user's computing device, where algorithms are used to extract dimensional data from images captured and obtaining measurements direct from the user. The 3D shopping environment gives users the ability to shop in the same way they would in a shopping mall, with all the realism of brick and mortar stores.

The 3D representations of the items may be created using the manufacturing specifications of the item(s) and directly rendering 3D models from the specifications. Alternatively, 3D cameras may be used to photograph the items on static mannequins to render exact 3D models. The first method may be preferred as it incorporates precise dimensions and stitching patterns into the representations.

Referring now more specifically to the drawings by numerals of reference, there is shown in FIGS. 1-11, various views of a virtual shopping software system and method 100 according to an embodiment of the present disclosure. FIG. 1 shows a front view of the virtual shopping software system and method 100, according to an embodiment of the present disclosure. The virtual shopping software system and method 100 may include a method of providing a virtual shopping software system 100. The virtual shopping software system 100 may comprise a computing device 110 hosting an application and in communication with a product supplier via a communication network, and a database that may be coupled to the computing device 110 and storing therein at least one product selection. The virtual shopping software system 100 may generate a three-dimensional (3D) store environment representing 140 a bricks-and-mortar store. The product supplier may remotely upload the at least one product selection from the database to the three-dimensional (3D) store environment 140 via the communication network, and/or to a catalog 136.

The virtual shopping software system and method 100 may further include registering a user, generating an avatar representing the user via a camera 122 coupled to the computing device 110, communicating with user(s) on the virtual shopping software system 100, selecting the at least one product selection from the three-dimensional (3D) store environment 140, displaying the at least one product selection on the avatar, and purchasing the at least one product selection.

The virtual shopping software system and method 100 may include means for advertising the at least one product selection to user(s) and logging events and activity of the user on the database. Further, the virtual shopping software system and method 100 may provide capacity to communicate with a product supplier billing for purchasing the at least one product selection. All the steps associated with the virtual shopping software system and method 100 may be performed remotely via a wireless connection (i.e. Internet).

The virtual shopping software system and method 100 may further comprise a plurality of artificial-intelligence-items. The plurality of artificial-intelligence-items may include behavioral learning, database mapping, object recognition, statistical learning, comparisons, coordinate system mapping, etc. The plurality of artificial-intelligence-items may be integrated to achieve extrapolating data, run algorithms, calculate dimensions, changing body sizes, etc. that may allow features of the present disclosure to be capable. The plurality of artificial-intelligence-items may additionally provide a structured marketing analytics for the product suppliers.

More particularly, the virtual shopping system 100 may apply machine learning and artificial intelligence to collected data from the user and applied to create user profiles which may then be shared with the store(s) to produce an individually tailored shopping experience for the user within the virtual shopping system.

An interface 120 may be communicably coupled to the computing device 110. The interface 120 as illustrated in FIG. 11 may include but not limited to a scrapbook 138, a virtual-fitting-room 132, a virtual-wardrobe 134, the three-dimensional (3D) store environment 140, a calendar, the catalog 136, and a shopping-cart. As illustrated in FIG. 1, a home screen 130 may be included with the interface 120. The home screen 130 may include access to the three-dimensional (3D) store environment 140, the virtual-fitting-room 132, the virtual-wardrobe 134, the catalog 136, the scrapbook 138, the calendar, and settings associated with the application. The home screen 130 may also showcase the advertising of the at least one product selection. Advertising may include desired advertisement designated from the product supplier and from the preferences of the user. Preferences of the user may be recorded to the database by logging events and activity of the user.

The tracked data may include, but is not limited to: Demographic data (name, age, gender, location, connected users, connected social media, system settings preferences, and anatomical measurements—both retrieved and provided), Store data (the stores a user visits, the sequence/order stores are visited, time spent in each store), Item data (time spent looking at each individual purchasable item, colors of each item, style of each item, the order items are viewed in, items browsed and not chosen to try on, time spent viewing items not chosen to try on, items chosen to try on, time spent viewing items chosen to try on (before trying them on), items chosen to purchase) and User preference data (time spent viewing garments on their virtual avatar, reviews of size/fit after purchase, combination of items selected as potential outfits, and particular views/angles in which the user spends more time viewing items).

Further, this data may be analyzed through machine learning processes to determine both user and store tendencies. The analysis of the user data may then be cross-correlated with then store data which may then provide the individual stores with customized datasets. Some potential customized datasets may include: Average body size and measurements of all their customers or by specified demographic; Comparison of body shapes and sizes to retailer garment measurements; Style preference averages (in total, by brand, customer or any other custom dataset collection); Color preference averages (in total, by brand, customer or any other custom dataset collection); Store preference averages (in total, per customer or any other custom dataset collection); Customer movement through shopping experience and averages incurred therein. From these datasets broader trends in behavioral shopping style statistics (e.g. how people like to shop) may be created, with the ability to combine and correlate the data in nearly any combination desired.

From a user (customer/consumer) perspective, datasets created through machine learning evolve over time and enable them to understand their specific behaviors and preferences and provide automatic picks of garments, accessories, styles, colors, stores, sales, discounts, promotions, and more, to give them the best possible shopping experience. In this way, the user may save time and money by finding what they want more readily while also making their purchases far more favored and therefore reduce returns even more than the initial reduction through perfect size and fit. This may then also provide a more entertaining special, customized and unique shopping experience for the users.

From a store (retailer) perspective the datasets created through machine learning similarly evolve over time and cater to understanding the overall consumer base as well as the individual customers. Through the customized datasets, along with anthropomorphic measurements, retailers may be able to understand how customers think and behave during their entire shopping experience. This insight may allow retailers, to remodel their brand, their customer experience and their fashion lines in ways that cater to and provide greater value for their customers on both an individual and collective basis.

FIG. 2 shows a front view of the virtual shopping software system and method 100 of FIG. 1, according to an embodiment of the present disclosure. As above, the virtual shopping software system and method 100 may include the interface 120 communicably coupled to the computing device 110 and having the virtual-fitting-room 132. The virtual-fitting-room 132 may include an avatar item interface to allow displaying the at least one product selection on the avatar. Displaying the at least one product selection on the avatar may include dragging and dropping the at least one product selection to the avatar. The avatar may be rotated in any direction. In addition, the user may have the ability to move body parts associated with the avatar. Snapshots of the avatar may be taken and shared with other user(s) and social media/email sharing tools or saved to the scrapbook 138.

FIG. 3 shows a front view of the virtual shopping software system and method 100 of FIG. 1, according to an embodiment of the present disclosure. As above, the virtual shopping software system and method 100 may include the interface 120 communicably coupled to the computing device 110 and having the virtual-wardrobe 134. Purchasing the at least one product selection may add the at least one product selection to the virtual-wardrobe 134. The user may take the at least one product selection from the virtual-wardrobe 134 to the virtual-fitting-room 132, the scrapbook 138, or utilize the social media/email sharing tools. Additionally, the virtual-wardrobe 134 may be accessed from the three-dimensional (3D) store environment 140 or the catalog 136. The virtual-wardrobe 134 may provide the user with the ability to use the at least one product selection purchased prior with new ones purchased recently.

The use of the virtual wardrobe may be tracked to provide both first-level data (e.g. products actually selected) and second-level data (e.g. combination of products selected, such as matching accessories). Applying machine learning algorithms to the collected data enables the system to provide future recommendations for direct products, and as well as indirect products, based on the collected data and evolving as tracked over time. This process allows for the capture and analysis of greater trends at both the individual consumer level and the collective consumer level. This may include seasonal shifts (e.g. summer/winter), regional variations and preferences, and potential broader trends in styles, colors and designs.

The three-dimensional (3D) store environment 140 may represent the bricks-and-mortar store, the mall, or other store environments. The three-dimensional (3D) store environment 140 may be customized and include a variety of design layouts. The product suppliers may design the three-dimensional (3D) store environment 140 based on geographic regions or demographics. The store environment may be provided with by the retailer or the system, but is preferably customizable to the retailer. The layout may be entirely virtual, or may be designed to partially or fully replicate an existing physical store layout. The store environment 140 may be further customized according to machine learning via tracking customer behavior within the store environment 140 in addition to the other machine learning behaviors and data described herein. For example, the customer's eye movements may be tracked to determine optimal layouts for shelves and displays within the store environment 140. Other customizations, such as only displaying in stock items, and/or items in the customer's preferred sizes and color, as indicated by the collecting and analyzed data, may also be applied to the store environment 140.

The store layout may be further constrained by the system according to the data analysis from both the user and the store. As discussed, the application of machine learning algorithms enables the store layout to change to reflect the user's current preferences. For example, at the store level, the display may be restricted to only those items which are available for the user to purchase, such as shipping restrictions. Additionally, the layout may then be further restricted to reflect the user preferences, such as size, color and style. By then tracking the user's interaction with the store layout, the layout may be evolved over time to adjust to any changes in the user's behavior. Finally, the layout may be customized to each user, and common elements and trends identified which may then be applied to physical store locations, if desired.

Optionally, the store may provide for in-person pickup of items at a physical store location. In this case, the user's location may be applied to determine nearby physical stores and the displayed items modified to reflect both the availability of an in-person pickup option for the item, as well as the item's availability in the physical store(s).

Additionally, multiple store environments 140 may be combined to create a virtual mall environment comprised of the multiple store environments. As with the individual store environments, the mall environment may be customized, including reflecting a physical mall environment. Customization may be applied from both the individual customers as well as machine learning applied to groups of customers. Referring to the option above, the multiple stores may provide for in-person pickup in a collective manner, if desired, whether at a physical mall location, or a separate designated location (e.g. one of the stores).

FIG. 4 shows a front view of the virtual shopping software system and method 100 of FIG. 1, according to an embodiment of the present disclosure. As above, the virtual shopping software system and method 100 may include the interface 120 communicably coupled to the computing device 110 and having the catalog 136. The catalog 136 may display existing or custom designed fashion magazines into computerized versions. The user may utilize the catalog 136 when shopping for the at least one product selection. In addition, the user may select the at least one product selection from the catalog 136, and drag and drop them to the virtual-fitting-room 132, the scrapbook 138 or shared with other user(s) with the social media/email sharing tools. The catalog 136 may represent fashion magazines, or other custom catalogs.

The catalog 136 may be provided as a separate user interface element, which further may enable separate digitized content from the catalog 136 which may be added to the store environment 140. The digitized content may be independently provided as a separate source of potential customer items as well as a separate source of data collection. Thus, the user's interaction with the digitized content in the catalog 136 may be added to the machine learning process described above to further enhance the output and reliability of the machine learning processes.

The content within the catalog may be selected and modified by the system based on data analysis from the machine learning components. For example, products may be initially selected based on consumer preferences (e.g. style/color), and then modified or restricted based on further data (e.g. size, availability). Accordingly, the catalog may be customized to the user, and evolve of time to reflect their current preferences and desires.

FIG. 5 shows a front view of the virtual shopping software system and method 100 of FIG. 1, according to an embodiment of the present disclosure. As above, the virtual shopping software system and method 100 may provide the capacity to communicate with the product supplier billing for purchasing the at least one product selection. Additionally, the user may have the capacity to choose if they want the at least one product selection to be picked-up/delivered. Further customization may include providing real-time inventory data to the user of nearby product suppliers with the at least one product selection in stock.

FIG. 6 shows a front view of the virtual shopping software system and method 100 of FIG. 1, according to an embodiment of the present disclosure. As stated above, the virtual shopping software system and method 100 may include the step of registering the user. A profile 152 may be associated with registering the user. The profile 152 may store a plurality of user-information and the social media/email sharing tools. Additionally, the profile 152 may invite other users to shop for them (permitting other users to use their avatar) or ask other users for permission to use their avatar.

FIGS. 7-8 show front views of the virtual shopping software system and method 100 of FIG. 1, according to an embodiment of the present disclosure. As above, the virtual shopping software system and method 100 may include the method of generating the avatar representing the user using real-world data, such as data captured via the camera 122 coupled to the computing device 110. Generating the avatar may include the steps of extrapolating data from two-dimensional (2D) images and videos taken via the camera 122, processing size-dimensions of the two-dimensional (2D) images and videos, and obtaining a three-dimensional representation of the avatar. Generating the avatar, in conjunction with measurements obtained for the at least one product selection, may enable the user to automatically have the correct sized apparel. The two-dimensional (2D) images and videos may comprise approximately 3 to 6 images and 1 video. However, as technology advances, and as the plurality of artificial-intelligence-items collects more anthropomorphic data, adjustments to the number of images and videos needed may change. Moreover, the two-dimensional (2D) images and videos may include different positions of the user to accurately generate the avatar.

FIG. 9 shows a front view of the virtual shopping software system and method 100 of FIG. 1, according to an embodiment of the present disclosure. As above, the virtual shopping software system and method 100 may further include communicating with user(s). Communicating with user(s) may include sending invites to share with the user(s), shop for user(s), or allow user(s) to shop for the current user (i.e. “Shop-For-Friends”). Further, sharing with the user(s) may include the social media/email sharing tools. The social media/email sharing tools may provide the user the ability to collect items they wish to share, sort and organize these items here, then delegate which groups of items they wish to share with which the social media/email tools by selecting corresponding icons and grouped items, and then sending to all destinations desired.

FIG. 10 shows a front view of the virtual shopping software system and method 100 of FIG. 1, according to an embodiment of the present disclosure. As above, the virtual shopping software system and method 100 may include the interface 120 communicably coupled to the computing device 110. The interface 120 may include the scrapbook 138. The scrapbook 138 may allow the users to scrapbook the at least one product selection for any reason and in any fashion. Primarily users may paste images of the at least one product selection, either wearing it on the avatar or not, as desired in the scrapbook 138. Default categories of the scrapbook 138 may include a wish list and past/future events. Users may have the option to create their own categories in the scrapbook 138. The scrapbook 138 may include access to the virtual-fitting-room 132, the virtual-wardrobe 134, the catalog 136, the calendar, etc.

The virtual shopping software system 100 may further includes as part of interface 120 an augmented reality interface to permit augmented reality interactions within physical stores that interact with either the physical store, the virtual storefront, or both. For example, a physical store could provide an in-store “scavenger hunt” through the augmented reality interface that provides rewards (e.g. coupons, discounts) for items that could be redeemed either in-store or as part of the virtual storefront. This augmented reality interface may further provide for interaction with other augmented reality programs and games (e.g. Pokémon Go; Minecraft Earth) to enable cross-branding and promotions with those programs.

Upon reading this specification, it should be appreciated that, under appropriate circumstances, considering such issues as user preferences, design preference, structural requirements, marketing preferences, cost, available materials, technological advances, etc., other virtual shopping software system and method 100 arrangements such as, for example, the interface 120, generating the avatar, etc., may be sufficient.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A virtual shopping system, comprising:
a user interface, the user interface presenting a virtual storefront wherein the user interacts with the virtual storefront to perform shopping activities, the shopping activities comprising one or more of: viewing an item; purchasing an item; trying on an item; returning an item; and rejecting an item;
a data collection system, the data collection system operative to collect data from the user performance of shopping activities, the collected data associated to the user and at least one store;
a machine learning system, the machine learning system operative to analyze the collected data and produce data analysis results, the data analysis results comprising one or more of: past individual user trends, predicted future individual user trends, past store trends and predicted future store trends.
wherein the data analysis results are applied to modify the virtual storefront to present a customized virtual storefront to the user.

2. The virtual shopping system of claim 1, further comprising a virtual wardrobe, the virtual wardrobe operative to store virtual representations of clothing items, and an interface to produce a virtual representation of the user wearing one or more of the clothing items.

3. The virtual shopping system of claim 2, wherein the clothing items comprising one or more of: clothing items purchased by the user; clothing items desired by the user; and clothing items suggested by the machine learning system.

4. The virtual shopping system of claim 1, further comprising a scrapbook, the scrapbook comprising one or more items selected by the user for future reference.

5. The virtual shopping system of claim 4, wherein the machine learning system further analyzes the scrapbook as part of the collected data.

6. The virtual shopping system of claim 1, further comprising multiple virtual storefronts, each virtual storefront representing an individual retailer and each virtual storefront is individually modified.

7. The virtual shopping system of claim 6, further comprising presenting a virtual mall created from a combination of the virtual storefront.

8. The virtual shopping system of claim 1, wherein the modifications to the virtual storefront include one or more of: item color, item size and item availability.

9. The virtual shopping system of claim 1, further comprising a social media interface, the social media interface providing for data exchange between the data collection system and one or more social media systems.

10. The virtual shopping system of claim 9, further comprising a user interface to permit user sharing of data with other users of the social media systems.

11. The virtual shopping system of claim 1, further comprising a catalog, the catalog comprising a virtual magazine, the virtual magazine comprising one or more virtual page displays containing one or more items for user interaction.

12. The virtual shopping system of claim 11, wherein the one or more items includes items other than items available through the virtual storefront.

13. The virtual shopping system of claim 1, further comprising a 3-dimensional user avatar interface, the avatar interface comprising a 3-dimensional avatar of the user, the avatar created according to real-world data about the user, the real-world data including at least one physical measurement of the user.

14. The virtual shopping system of claim 13, wherein the avatar interface further comprises an avatar item interface, the avatar item interface operative to permit the user to modify the avatar with one or more items to change how the avatar appears.

15. The virtual shopping system of claim 14, wherein the avatar item interface comprises items selected from one of more of: items previously purchased by the user; items available from the virtual storefront, and items identified by the user for potential future purchase.

16. The virtual shopping system of claim 1, further comprising a location module to determine the user's location and incorporate the user's location into the data analysis.

17. The virtual shopping system of claim 16, wherein the user's location is used to determine relevant physical stores and present in-person pickup options for items at one or more of the relevant physical stores.

18. The virtual shopping system of claim 1, further comprising an augmented reality interface operative to enable the user to participate in augmented reality interactions in physical stores.
